(19) United States
(12) Patent Application Publication
(10) Pub. No.: US 2020/0269497 A1
(43) Pub. Date: Aug. 27, 2020

(54) ADDITIVE MANUFACTURING METHOD FOR MAKING A THREE-DIMENSIONAL OBJECT USING SELECTIVE LASER SINTERING

(71) Applicant: SOLVAY SPECIALTY POLYMERS USA, LLC, Alpharetta, GA (US)

(72) Inventors: Stéphane JEOL, Cumming, GA (US); Christopher WARD, Sandy Springs, GA (US); Vito LEO, Glimes (Incourt) (BE)

(21) Appl. No.: 16/646,159

(22) PCT Filed: Sep. 14, 2018
(86) PCT No.: PCT/EP2018/074982

§ 371 Date: Mar. 11, 2020

Related U.S. Application Data
(60) Provisional application No. 62/559,956, filed on Sep. 18, 2017.

(30) Foreign Application Priority Data
Dec. 14, 2017 (EP) 17207190.4

(51) Int. Cl. B29C 64/153; B29C 64/40; B29C 64/268

(52) U.S. Cl. CPC B29C 64/153; B33Y 10/00; B29C 64/268; B29C 64/40

(57) ABSTRACT

The present disclosure relates to an additive manufacturing (AM) method for making a three-dimensional (3D) object, comprising a) the provision of providing a powdered polymer material (M) comprising at least one polymer (P1) having a melting temperature (Tm) greater than 270° C., as measured by differential scanning calorimetry (DSC) according to ASTM D3418, and at least one polymer (P2) having a glass transition temperature (Tg) between 130° C. and 240° C., and no melting peak, as measured by differential scanning calorimetry (DSC) according to ASTM D3418, b) the deposition of successive layers of the powdered polymer material; and c) the selective sintering of each layer prior to the deposition of the subsequent layer, wherein the powdered polymer material (M) is heated before step c) to a temperature Tp (° C.): Tp<Tg+25, wherein Tg (° C.) is the glass transition temperature of the P2 polymer.

### RELATED APPLICATIONS

This application claims priority to U.S. provisional application 62/559,956 filed on Sep. 18, 2017 and to European application 17207190.4 filed on Dec. 14, 2017, the whole content of each of these applications being incorporated herein by reference for all purposes.

### TECHNICAL FIELD

The present disclosure relates to an additive manufacturing (AM) method for making a three-dimensional (3D) object, using a powdered polymer material (M) comprising at least one semi-crystalline polymer (P1), in particular to a 3D object obtainable by laser sintering from this powdered polymer material (M).

### BACKGROUND

Additive manufacturing systems are used to print or otherwise build 3D objects from a digital blueprint created with computer-aided design (CAD) modelling software. Selective laser sintering (“SLS”), one of the available additive manufacturing techniques, uses electromagnetic radiation from a laser to fuse powdered materials into a mass. The laser selectively fuses the powdered material by scanning cross-sections generated from the digital blueprint of the object on the surface of a powder bed. After a cross-section is scanned, the powder bed is lowered by one layer thickness, a new layer of material is applied, and the bed is rescanned. Locally full coalescence of polymer particles in the top powder layer is necessary as well as an adhesion with previous sintered layers. This process is repeated until the object is completed.

In the powder bed of the SLS printer, the powdered material is generally preheated to a processing temperature close to the melting point (Tm) of the resin. For semi crystalline polymers, crystallization (Tc) should be inhibited during printing as long as possible, at least for several sintered layers. The processing temperature must therefore be precisely adjusted between the melting temperature (Tm) and the crystallization temperature (Tc) of the semi crystalline polymer, also called the “sintering window”. The preheating of the powder makes it easier for the laser to raise the temperature of the selected regions of layer of unfused powder to the melting point. The laser causes fusion of the powder only in locations specified by the input. Laser energy exposure is typically selected based on the polymer in use and to avoid polymer degradation.

When the process is completed, the non-fused powder is removed from the 3D object and can be recycled and reused in a subsequent SLS process.

Producing an article by laser sintering can take a long time, frequently more than 16 hours, even for small articles. This means that the powder material is submitted to high temperatures in the powder bed of the SLS printer for an extended period of time (called thermal aging). This can irreversibly affect the polymer material, in such a way that it is not recyclable anymore. Not only the chemical nature of the polymer is changed due to thermal aging, but also its mechanical properties of the polymer material such as its toughness. For some semi crystalline polymers, such as poly(ether ether ketone) (PEEK) or polyphenylene sulphide (PPS), the processing temperature is too high, causing degradation and/or crosslinking, which negatively affect SLS processability and recycling. The potential of the SLS process is therefore limited by the restricted number of materials optimised for the process.

The laser sintering 3D printing method of the present invention is based on the use of a powdered material made of a blend of polymers comprising at least a semi-crystalline polymer and at least one amorphous polymer, without significantly degrading and/or crosslinking the powdered material, thereby allowing unsintered material to be recycled and used in the manufacture of a new 3D object.

### SUMMARY

The present invention relates to an additive manufacturing method for making a three-dimensional (3D) object. The method comprises the steps of:

a) providing a powdered polymer material (M) comprising:
from 55 to 95 wt. % of at least one polymer (P1) having a melting temperature (Tm) greater than 270° C., as measured by differential scanning calorimetry (DSC) according to ASTM D3418, and
from 5 to 45 wt. % of at least one polymer (P2) having a glass transition temperature (Tg) between 130° C. and 240° C., and no melting peak, as measured by differential scanning calorimetry (DSC) according to ASTM D3418,

based on the total weight of the powdered polymer material (M);

b) depositing successive layers of the powdered polymer material (M); and

c) selectively sintering each layer prior to deposition of the subsequent layer,

wherein the powdered polymer material (M) is heated before step c) to a temperature Tp (° C.):

Tp<Tg+25

wherein Tg (° C.) is the glass transition temperature of the P2 polymer.

The method for manufacturing a 3D object of the present invention employs a powdered polymer material (M) comprising a semi-crystalline polymer as the main element of the polymer material, as well as an amorphous polymer. The powdered polymer material (M) can have a regular shape such as a spherical shape, or a complex shape obtained by grinding/milling of pellets or coarse powder.

The present invention also relates to a powdered polymer material (M) comprising at least one semi-crystalline polymer and at least one amorphous polymer, said material (M) having for example a d_{0.5}-value ranging from 25 and 90 μm, as measured by laser scattering in isopropanol, as well as to the method for the production of a powdered polymer material (M) comprising at least one semi-crystalline polymer and at least one amorphous polymer, said method comprising a step of grinding a blend of at least the semi-crystalline polymer and the amorphous polymer, the blend being optionally cooled down to a temperature a temperature below 25° C. before and/or during grinding.

The 3D objects or articles obtainable by such method of manufacture can be used in a variety of final applications. Mention can be made in particular of implantable device, medical device, dental prostheses, brackets and complex shaped parts in the aerospace industry and under-the-hood parts in the automotive industry.

### Disclosure of the Invention

The present invention relates to an additive manufacturing method for making a three-dimensional (3D) object. The method comprises a first step of providing a powdered polymer material (M) comprising from 55 to 95 wt. % of at least one polymer (P1), and from 5 to 45 wt. % of at least one polymer (P2), based on the total weight of the powdered polymer material (M). The polymer (P1) of the present invention has a melting temperature (Tm) greater than 270° C., as measured by differential scanning calorimetry (DSC) according to ASTM D3418, and the polymer (P2) of the present invention has a glass transition temperature (Tg) between 130° C. and 240° C., and no melting peak, as measured by differential scanning calorimetry (DSC) according to ASTM D3418.

The method of the invention also comprises a step of depositing successive layers of the powdered polymer material and a step of selectively sintering each layer prior to deposition of the subsequent layer.

According to the present invention, the powdered polymer material (M) is heated before the sintering step to a temperature Tp (° C.):

Tp<Tg+25

wherein Tg (° C.) is the glass transition temperature of the P2 polymer, as measured by differential scanning calorimetry (DSC) according to ASTM D3418.

The method of the present invention employs a powdered polymer material (M) comprising a semi-crystalline polymer (P1) as the main element of the polymer material, as well as an amorphous polymer (P2). The powdered polymer material (M) can have a regular shape such as a spherical shape, or a complex shape obtained by grinding/milling of pellets or coarse powder.

In the process of the present invention, the powdered polymer material (M) is heated, for example in the powder bed of a SLS printer, prior to the sintering of a selected area of the powder layer (for example, by means of an electromagnetic radiation of the powder), at a processing temperature (Tp) which is Tp<Tg+25, where Tg is the glass transition temperature of the amorphous polymer (P2). The combination of the material and the choice of a specific processing temperature (Tp), based on the material composition, makes possible the recycling of the unsintered material and its reuse in the manufacture of a new 3D object. The powdered polymer material (M) is not significantly affected by the long-term exposure to the processing temperature and presents a set of characteristics (namely powder aspect and color, disaggregation and coalescence abilities) which is comparable to a new, unprocessed polymer material. This makes the used powder completely suitable for reuse in a laser sintering 3D printing process, without impacting the appearance and mechanical performances of the resulting printed article (notably the expected performance of the polymer materials, e.g. the toughness of the PAEK).

Powdered Polymer Material (M)

The powdered polymer material (M) employed in the method of the present invention comprises:
from 55 to 95 wt. % of at least one polymer (P1) having a melting temperature (Tm) greater than 270° C., as measured by differential scanning calorimetry (DSC) according to ASTM D3418, and
from 5 to 45 wt. % of at least one polymer (P2) having a glass transition temperature (Tg) between 130° C. and 240° C., and no melting peak, as measured by differential scanning calorimetry (DSC) according to ASTM D3418,

based on the total weight of the powdered polymer material (M).

The powdered polymer material (M) of the invention may include other components. For example, the material (M) may comprise at least one additive, notably at least one additive selected from the group consisting of flow agents, fillers, colorants, lubricants, plasticizers, stabilizers, flame retardants, nucleating agents and combinations thereof. Fillers in this context can be reinforcing or non-reinforcing in nature.

In embodiments that include flow agents, the amount of flow agents in the material (M) ranges from 0.01 to 10 wt. %, with respect to the total weight of the part material.

In embodiments that include fillers, the amount of fillers in the material (M) ranges from 0.5 wt. % to 30 wt. %, with respect to the total weight of the material (M). Suitable fillers include calcium carbonate, magnesium carbonate, glass fibers, graphite, carbon black, carbon fibers, carbon nanofibers, graphene, graphene oxide, fullerenes, talc, wollastonite, mica, alumina, silica, titanium dioxide, kaolin, silicon carbide, zirconium tungstate, boron nitride and combinations thereof.

According to one embodiment, the material (M) of the present invention comprises:
from 56 to 95 wt. %, from 57 to 90 wt. %, from 58 to 85 wt. % or from 59 to 80 wt. % of at least one polymer (P1) having a melting temperature (Tm) greater than 270° C., as measured by differential scanning calorimetry (DSC) according to ASTM D3418, and
from 5 to 44 wt. %, from 10 to 43 wt. %, from 15 to 42 wt. % or from 20 to 41 wt. % of of at least one polymer (P2) having a glass transition temperature (Tg) between 130° C. and 240° C., and no melting peak, as measured by differential scanning calorimetry (DSC) according to ASTM D3418,
from 0 to 30 wt. % of at least one additive, or from 0.1 to 28 wt. % or from 0.5 to 25 wt. % of at least one additive, for example selected from the group consisting of flow agents, fillers, colorants, dyes, pigments, lubricants, plasticizers, flame retardants (such as halogen and halogen free flame retardants), nucleating agents, heat stabilizer, light stabilizer, antioxidants, processing aids, nanofillers and electomagnetic absorbers, based on the total weight of the powdered polymer material (M).

Polymer (P1)

According to an embodiment, the polymer (P1) is selected from the group consisting of a poly(aryl ether ketone) (PAEK), a polyphenylene sulfide (PPS), a polyphtalamide (PPA), a semi-aromatic polyester and an aromatic polyesters (PE).

When P1 is a PAEK, it is preferably a poly(ether ether ketone) (PEEK), a poly(ether ketone ketone) (PEKK), a poly(ether ketone) (PEK) or a copolymer of PEEK and poly(diphenyl ether ketone) (PEEK-PEDEK copolymer).

When the polymer is a PAS, it is preferably a poly(para-phenylene sulfide).

When the polymer is a PE, it is preferably a polyethylene naphthalate (PEN), a poly(1,4 cyclohexylenedimethylene terephthalate) (PCT) or a Liquid Crystalline Polyester (LCP).

Poly(aryl ether ketone) (PAEK)

As used herein, a poly(aryl ether ketone) (PAEK) denotes any polymer comprising recurring units (R_{PAEK}) comprising a Ar′—C(═O)—Ar* group, where Ar′ and Ar*, equal to or different from each other, are aromatic groups, the mol. % being based on the total number of moles of recurring units in the polymer. The recurring units (R_{PAEK}) are selected from the group consisting of units of formulas (J-A) to (J-D) below:

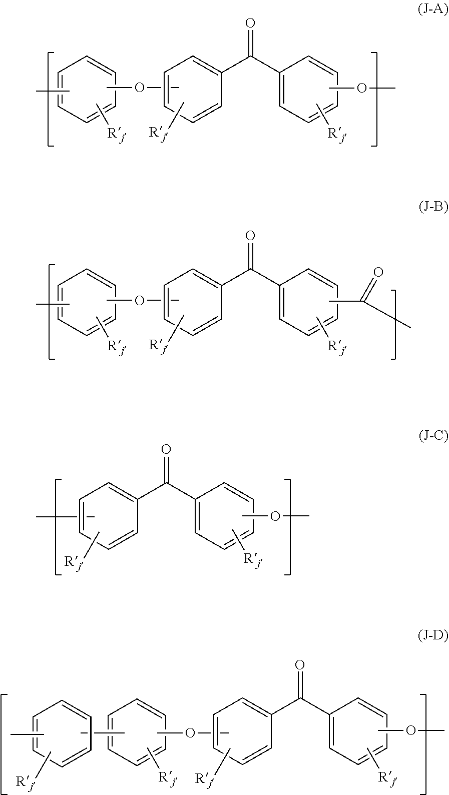

where

R′, at each location, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and

j′ is independently zero or an integer ranging from 1 to 4.

In recurring unit (R_{PAEK}), the respective phenylene moieties may independently have 1,2-, 1,4- or 1,3-linkages to the other moieties different from R′ in the recurring unit (R_{PAEK}). Preferably, the phenylene moieties have 1,3- or 1,4-linkages, more preferably they have a 1,4-linkage.

In recurring units (R_{PAEK}), j′ is preferably at each location zero so that the phenylene moieties have no other substituents than those linking the main chain of the polymer.

According to an embodiment, the PAEK is a poly(ether ether ketone) (PEEK).

As used herein, a poly(ether ether ketone) (PEEK) denotes any polymer comprising recurring units (R_{PEEK}) of formula (J-A), based on the total number of moles of recurring units in the polymer:

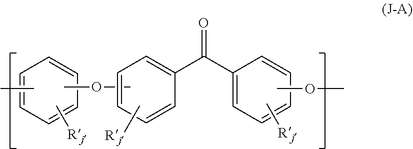

where

R′, at each location, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and

j′, for each R′, is independently zero or an integer ranging from 1 to 4 (for example 1, 2, 3 or 4).

According to formula (J-A), each aromatic cycle of the recurring unit (R_{PEEK}) may contain from 1 to 4 radical groups R′. When j′ is 0, the corresponding aromatic cycle does not contain any radical group R′.

Each phenylene moiety of the recurring unit (R_{PEEK}) may, independently from one another, have a 1,2-, a 1,3- or a 1,4-linkage to the other phenylene moieties. According to an embodiment, each phenylene moiety of the recurring unit (R_{PEEK}), independently from one another, has a 1,3- or a 1,4-linkage to the other phenylene moieties. According to another embodiment yet, each phenylene moiety of the recurring unit (R_{PEEK}) has a 1,4-linkage to the other phenylene moieties.

According to an embodiment, R′ is, at each location in formula (J-A) above, independently selected from the group consisting of a C1-C12 moiety, optionally comprising one or more than one heteroatoms; sulfonic acid and sulfonate groups; phosphonic acid and phosphonate groups; amine and quaternary ammonium groups.

According to an embodiment, j′ is zero for each R′. In other words, according to this embodiment, the recurring units (R_{PEEK}) are according to formula (J′-A):

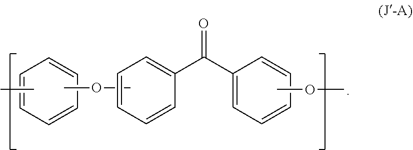

According to another embodiment of the present disclosure, a poly(ether ether ketone) (PEEK) denotes any polymer comprising at least 10 mol. % of the recurring units are recurring units (R_{PEEK}) of formula (J-A″):

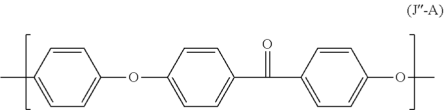

the mol. % being based on the total number of moles of recurring units in the polymer.

According to an embodiment of the present disclosure, at least 10 mol. % (based on the total number of moles of recurring units in the polymer), at least 20 mol. %, at least 30 mol. %, at least 40 mol. %, at least 50 mol. %, at least 60 mol. %, at least 70 mol. %, at least 80 mol. %, at least 90 mol. %, at least 95 mol. %, at least 99 mol. % or all of the recurring units in the PEEK are recurring units (R_{PEEK}) of formulas (J-A), (J′-A) and/or (J″-A).

The PEEK polymer can therefore be a homopolymer or a copolymer. If the PEEK polymer is a copolymer, it can be a random, alternate or block copolymer.

When the PEEK is a copolymer, it can be made of recurring units (R*_{PEEK}), different from and in addition to recurring units (R_{PEEK}), such as recurring units of formula (J-D):

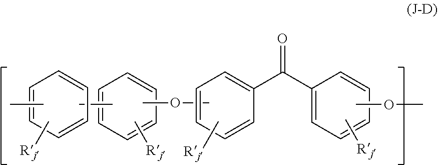

where

R′, at each location, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and

j′, for each R′, is independently zero or an integer ranging from 1 to 4.

According to formula (J-D), each aromatic cycle of the recurring unit (R*_{PEEK}) may contain from 1 to 4 radical groups R′. When j′ is 0, the corresponding aromatic cycle does not contain any radical group R′.

According to an embodiment, R′ is, at each location in formula (J-B) above, independently selected from the group consisting of a C1-C12 moiety, optionally comprising one or more than one heteroatoms; sulfonic acid and sulfonate groups; phosphonic acid and phosphonate groups; amine and quaternary ammonium groups.

According to an embodiment, j′ is zero for each R′. In other words, according to this embodiment, the recurring units (R*_{PEEK}) are according to formula (J′-D):

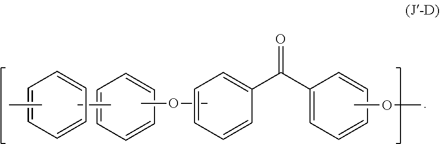

According to another embodiment of the present disclosure, the recurring units (R*_{PEEK}) are according to formula (J″-D):

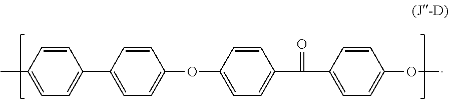

According to an embodiment of the present disclosure, less than 90 mol. % (based on the total number of moles of recurring units in the polymer), less than 80 mol. %, less than 70 mol. %, less than 60 mol. %, less than 50 mol. %, less than 40 mol. %, less than 30 mol. %, less than 20 mol. %, less than 10 mol. %, less than 5 mol. %, less than 1 mol. % or all of the recurring units in the PEEK are recurring units (R*_{PEEK}) of formulas (J-B), (J′-B), and/or (J″-B).

According to an embodiment, the PEEK polymer is a PEEK-PEDEK copolymer. As used herein, a PEEK-PEDEK copolymer denotes a polymer comprising recurring units (R_{PEEK}) of formula (J-A), (J′-A) and/or (J″-A) and recurring units (R_{PEEK}) of formulas (J-B), (J′-B) or (J″-B) (also called hereby recurring units (R_{PEDEK)}). The PEEK-PEDEK copolymer may include relative molar proportions of recurring units (R_{PEEK}/R_{PEDEK}) ranging from 95/5 to 5/95, from 90/10 to 10/90, or from 85/15 to 15/85. The sum of recurring units (R_{PEEK}) and (R_{PEDEK}) can for example represent at least 60 mol. %, 70 mol. %, 80 mol. %, 90 mol. %, 95 mol. %, 99 mol. %, of recurring units in the PEEK copolymer. The sum of recurring units (R_{PEEK}) and (R_{PEDEK}) can also represent 100 mol. %, of recurring units in the PEEK copolymer.

Defects, end groups and monomers' impurities may be incorporated in very minor amounts in the polymer (PEEK) of the present disclosure, without undesirably affecting the performance of the polymer in the polymer composition (C1).

PEEK is commercially available as KetaSpire® PEEK from Solvay Specialty Polymers USA, LLC.

PEEK can be prepared by any method known in the art. It can for example result from the condensation of 4,4′-difluorobenzophenone and hydroquinone in presence of a base. The reactor of monomer units takes place through a nucleophilic aromatic substitution. The molecular weight (for example the weight average molecular weight Mw) can be adjusting the monomers molar ratio and measuring the yield of polymerisation (e.g. measure of the torque of the impeller that stirs the reaction mixture).

According to one embodiment of the present disclosure, the PEEK polymer has a weight average molecular weight (Mw) ranging from 75,000 to 100,000 g/mol, for example from 77,000 to 98,000 g/mol, from 79,000 to 96,000 g/mol, from 81,000 to 95,000 g/mol, or from 85,000 to 94,500 g/mol (as determined by gel permeation chromatography (GPC) using phenol and trichlorobenzene (1:1) at 160° C., with polystyrene standards).

The powdered polymer material (M) of the invention may comprise PEEK in an amount of 55 to 95 wt. %, for example less than 60 to 90 wt. %, based on the total weight of M.

According to the present invention, the melt flow rate or melt flow index (at 400° C. under a weight of 2.16 kg according to ASTM D1238) (MFR or MFI) of the PEEK may be from 1 to 60 g/10 min, for example from 2 to 50 g/10 min or from 2 to 40 g/10 min.

In another embodiment, the PAEK is a poly(ether ketone ketone) (PEKK).

As used herein, a poly(ether ketone ketone) (PEKK) denotes a polymer comprising more than 50 mol. % of the recurring units of formulas (J-B₁) and (J-B2), the mol. % being based on the total number of moles of recurring units in the polymer:

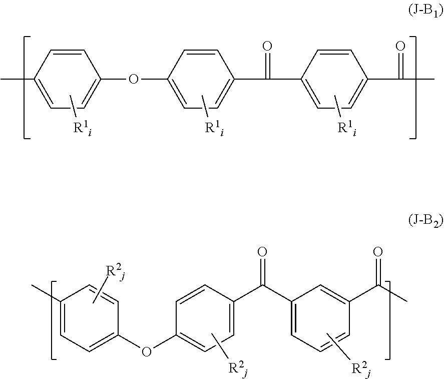

wherein

R¹ and R², at each instance, is independently selected from the group consisting of an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and

i and j, at each instance, is an independently selected integer ranging from 0 to 4.

According to an embodiment, R¹ and R² are, at each location in formula (J-B₂) and (J-B₁) above, independently selected from the group consisting of a C1-C12 moiety, optionally comprising one or more than one heteroatoms; sulfonic acid and sulfonate groups; phosphonic acid and phosphonate groups; amine and quaternary ammonium groups.

According to another embodiment, i and j are zero for each R¹ and R² group. According to this embodiment, the PEKK polymer comprises at least 50 mol. % of recurring units of formulas (J′-B₁) and (J′-B₂), the mol. % being based on the total number of moles of recurring units in the polymer:

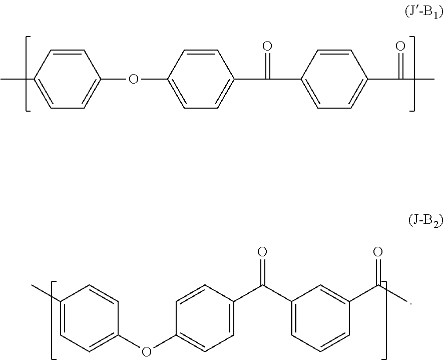

According to an embodiment of the present disclosure, at least 55 mol. %, at least 60 mol. %, at least 70 mol. %, at least 80 mol. %, at least 90 mol. %, at least 95 mol. %, at least 99 mol. % or all of the recurring units in the PEKK are recurring units of formulas (J-B₁) and (J-B₂).

According to an embodiment of the present disclosure, in the PEKK polymer, the molar ratio of recurring units (J-B₂) or/and (J′-B₂) to recurring units (J-B₁) or/and (J′-B₁) is at least 1:1 to 5.7:1, for example at least 1.2:1 to 4:1, at least 1.4:1 to 3:1 or at least 1.4:1 to 1.86:1.

The PEKK polymer has preferably an inherent viscosity of at least 0.50 deciliters per gram (dL/g), as measured following ASTM D2857 at 30° C. on 0.5 wt./vol. % solutions in concentrated H₂SO₄ (96 wt. % minimum), for example at least 0.60 dL/g or at least 0.65 dL/g and for example at most 1.50 dL/g, at most 1.40 dL/g, or at most 1.30 dL/g.

PEKK is commercially available as NovaSpire® PEKK from Solvay Specialty Polymers USA, LLC

Polyphenylene Sulfide (PPS)

As used herein, a polyphenylene sulfide (PPS) denotes any polymer comprising at least 50 mol. % of recurring units (Rpps) of formula (U) (mol. % being based on the total number of moles of recurring units in the PPS polymer):

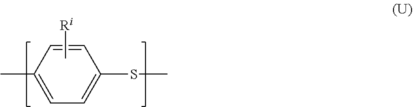

where

R is independently selected from the group consisting of halogen, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and i is independently zero or an integer from 1 to 4.

According to formula (U), the aromatic cycle of the recurring unit (R_{PPS}) may contain from 1 to 4 radical groups R. When i is zero, the corresponding aromatic cycle does not contain any radical group R.

According to an embodiment of the present invention, the PPS polymer denotes any polymer comprising at least 50 mol. % of recurring units (R_{PPS}) of formula (U′) where i is zero:

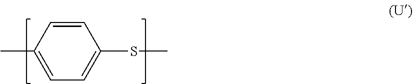

According to an embodiment of the present invention, the PPS polymer is such that at least 60 mol. %, at least 70 mol. %, at least 80 mol. %, at least 90 mol. %, at least 95 mol. %, at least 99 mol. % of the recurring units in the PPS are recurring units (R_{PPS}) of formula (U) or (U′). The mol. % are based are based on the total number of moles of recurring units in the PPS polymer.

According to an embodiment of the present invention, the PPS polymer is such that 100 mol. % of the recurring units are recurring units (R_{PPS}) of formula (U) or (U′). According to this embodiment, the PPS polymer consists essentially of recurring units (R_{PPS}) of formula (U) or (U′).

PPS is commercially available under the tradename Ryton® PPS from Solvay Specialty Polymers USA, LLC.

The melt flow rate (at 316° C. under a weight of 5 kg according to ASTM D1238, procedure B) of the PPS may be from 50 to 400 g/10 min, for example from 60 to 300 g/10 min or from 70 to 200 g/10 min.

Polyphtalamide (PPA)

As used herein, a polyphthalamide (PPA) denotes any polymer comprising at least 50 mol. % of recurring units (RPDA) (based on the total number of moles in the polymer) formed by the polycondensation of at least phthalic acid and at least aliphatic diamine. The phthalic acid can for example be selected from the group consisting of o-phthalic acid, isophthalic acid and terephthalic acid. The aliphatic diamine can for example be selected from the group consisting of hexamethylenediamine, 1,9-nonanediamine, 1,10-diaminodecane, 1,12-diaminododecane, 2-methyl-octanediamine, 2-methyl-1,5-pentanediamine, 1,4-diaminobutane. C6 diamines are prefered, in particular hexamethylenediamine.

Among polyphthalamides (PPA), polyterephthalamides (PTPA) are preferred. Polyterephthalamides are aromatic polyamides comprising at least 50 mol. % of recurring units (R_{PTPA}) formed by the polycondensation of at least terephthalic acid (TPA) and at least one aliphatic diamine.

According to a first embodiment, the polyterephthalamides (PTPA) comprise at least 60 mol. %, at least 70 mol. %, at least 70 mol. %, at least 80 mol. %, at least 90 mol. %, at least 95. mol% or at least 99 mol. % of recurring units (R_{PTPA}) formed by the polycondensation of at least terephthalic acid (TPA) and at least one aliphatic diamine. According to this embodiment, a preferred diamine is a C6 diamine and/or a C9 diamine and/or C10 diamine.

According to a second embodiment, the polyterephthalamides (PTPA) comprise recurring units formed by the polycondensation of terephthalic acid (PTA), isophthalic acid (IPA) and at least one aliphatic diamine. According to this embodiment, a preferred polyterephthalamide comprises at least 50 mol. % or consists essentially of recurring units formed by the polycondensation of terephthalic acid (PTA) and at least one aliphatic diamine and of recurring units formed by the polycondensation of isophthalic acid (IPA) and at least one aliphatic diamine, in a mole ratio ranging between 60:40 and 90:10 (mol. %).

According to a third embodiment, the polyterephthalamides (PTPA) comprise recurring units formed by the polycondensation reaction between terephthalic acid (TPA), at least one aliphatic diacid and at least one aliphatic diamine. The aliphatic diacid can for example be selected from the group consisting of adipic acid and sebacic acid. Adipic acid is preferred. According to this embodiment, a preferred polyterephthalamide comprises at least 50 mol. % or consists essentially of recurring units formed by the polycondensation of terephthalic acid (TPA) and at least one aliphatic diamine and of recurring units formed by the polycondensation of at least one aliphatic diacid and at least one aliphatic diamine, in a mole ratio ranging between 55:45 and 75:25 (mol. %).

According to a fourth embodiment, the polyterephthalamides (PTPA) comprise recurring units formed by the polycondensation of terephthalic acid (TPA), isophthalic acid (IPA), at least one aliphatic diacid and at least one aliphatic diamine. The aliphatic diacid can for example be selected from the group consisting of adipic acid and sebacic acid. Adipic acid is preferred. According to this embodiment, a preferred polyterephthalamide comprises at least 50 mol. % or consists essentially of recurring units (R1) formed by the polycondensation of terephthalic acid (TPA) and at least one aliphatic diamine, of recurring units (R2) formed by the polycondensation of isophthalic acid (IPA) and at least one aliphatic diamine, and of recurring units (R3) formed by the polycondensation of at least one aliphatic diacid and at least one aliphatic diamine. In this case, the mole ratio of recurring units (R1): (R2)+(R3) may range from 55:45 to 75:25 (mol %) and the mole ratio (R2):(R3) may range from 60:40 to 85:15.

The polyphtalamide (PPA) is semi-crystalline. The melting point of the PPA may be greater than 275° C., preferably greater than 290° C., more preferably greater than 305° C., and still more preferably greater than 320° C.

PPA is commercially available under the tradename Amodel® from Solvay Specialty Polymers USA, LLC.

Semi-Aromatic and Aromatic Polyesters (PE).

As used herein, a semi-aromatic or aromatic polyesters denotes any polymer comprising at least 50 mol. %, of recurring units (RPE) comprising at least one ester moiety of formula R—COO—R and at least one aromatic moiety.

The polyesters of the present invention may be obtained by polycondensation of an aromatic monomer (MA) comprising at least one hydroxyl group and at least one carboxylic acid group or by polycondensation of at least one monomer (MB) comprising at least two hydroxyl groups (a diol) and at least one monomer (MC) comprising at least two carboxylic acid groups (a dicarboxylic acid), with at least one of the monomers (MB) or (MC) comprising an aromatic moiety.

Non limitative examples of monomers (MA) include 4 hydroxybenzoic acid, 6-hydroxynaphthalene-2-carboxylic acid.

Non limitative examples of monomers (MB) include 1,4 cyclohexanedimethanol; ethylene glycol; 1,4-butanediol; 1,3-propanediol; 1,5 pentanediol, 1,6-hexanediol; and neopentyl glycol, while 1,4 cyclohexanedimethanol and neopentyl glycol are preferred.

Non limitative examples of monomers (MC) include terephthalic acid, isophthalic acid, naphthalene dicarboxylic acids, cyclohexane dicarboxylic acid, succinic acid, sebacic acid, and adipic acid, while terephthalic acid and cyclohexane dicarboxylic acid are preferred.

Depending on the choice of monomers, polyesters (PE) can be either wholly semi-aromatic or aromatic. They can be copolymers or homopolymers.

According to an embodiment, when the polyester of the invented composition is a copolymer, at least 50 mol. %, at least 60 mol. %, at least 70 mol. %, at least 80 mol. %, or at least 90 mol. % of the recurring units are obtained through the polycondensation of terephthalic acid.

According to another embodiment, when the polyester of the invented composition is a copolymer, at least 50 mol. %, at least 60 mol. %, at least 70 mol. %, at least 80 mol. %, or at least 90 mol. % of the recurring units are obtained through the polycondensation of terephthalic acid with 1,4-cyclohexylenedimethanol.

When the polyester of the invented composition is a homopolymer, it may be selected from the group consisting of a polyethylene naphthalate (PEN), a poly(l,4 cyclohexylenedimethylene terephthalate) (PCT), and a Liquid Crystalline Polyester (LCP). It is preferably a PCT (i.e. a homopolymer obtained through the polycondensation of terephthalic acid with 1,4-cyclohexylenedimethanol).

The polyesters used herein have advantageously an intrinsic viscosity of from about 0.6 to about 2.0 dl/g as measured in a 60:40 phenol/tetrachloroethane mixture or similar solvent at about 30° C. Particularly suitable polyesters for this invention have an intrinsic viscosity of 0.6 to 1.4 dl/g.

The melting point of the PE may be greater than 270° C., and still more preferably greater than 280° C.

Polymer (P2)

According to an embodiment, the polymer (P2) is selected from the group consisting of poly(aryl ether sulfone) (PAES), poly(ether imide) (PEI), polycarbonate (PC), poly(phenyl ether) (PPE), amorphous polyamide with a glass transition temperature above 130° C. (for example Selar® PA 61/6T 70/30, Rilsan® Clear, Grilamid® TR, Grivory® G and Trogamid®), and amorphous aromatic polyester (for example U-Polymer® from Unitika).

When the polymer (P2) is a poly(aryl ether sulfone) (PAES), it is preferably a polyphenylsulfone (PPSU), a polyethersulfone (PES) or a polysulfone (PSU).

Poly(Aryl Ether Sulfone) (PAES)

For the purpose of the present invention, a “poly(aryl ether sulfone) (PAES)” denotes any polymer comprising at least 50 mol. % of recurring units (R_{PAES}) of formula (K), based on the total number of moles in the polymer:

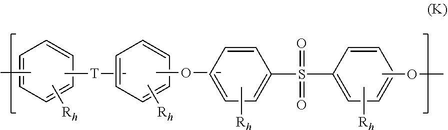

where
R, at each location, is independently selected from a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
h, for each R, is independently zero or an integer ranging from 1 to 4; and
T is selected from the group consisting of a bond and a group —C(Rj)(Rk)-, where Rj and Rk, equal to or different from each other, are selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium.

According to an embodiment, Rj and Rk are methyl groups.

According to an embodiment, h is zero for each R. In other words, according to this embodiment, the recurring units (R_{PAEs}) are units of formula (K′):

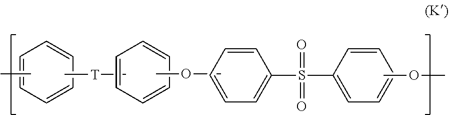

According to an embodiment of the present invention, at least 60 mol. %, at least 70 mol. %, at least 80 mol. %, at least 90 mol. %, at least 95 mol. %, at least 99 mol. % or all of the recurring units in the PAES are recurring units (R_{PAES}) of formula (K) or formula (K′).

According to an embodiment, the PAES has a Tg ranging from 160 and 250° C., preferably from 170 and 240° C., more preferably from 180 and 230° C., as measured by differential scanning calorimetry (DSC) according to ASTM D3418.

According to an embodiment, the poly(aryl ether sulfone) (PAES) is a poly(biphenyl ether sulfone) (PPSU).

A poly(biphenyl ether sulfone) polymer is a polyarylene ether sulfone which comprises a biphenyl moiety. Poly(biphenyl ether sulfone) is also known as polyphenyl sulfone (PPSU) and for example results from the condensation of 4,4′-dihydroxybiphenyl (biphenol) and 4,4′-dichlorodiphenyl sulfone.

For the purpose of the present invention, a poly(biphenyl ether sulfone) (PPSU) denotes any polymer comprising at least 50 mol. % of recurring units (R_{PPSU}) of formula (L), based on the total number of moles in the PPSU polymer:

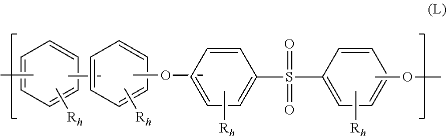

where
R, at each location, is independently selected from a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
h, for each R, is independently zero or an integer ranging from 1 to 4.

According to an embodiment, R is, at each location in formula (L) above, independently selected from the group consisting of a C1-C12 moiety optionally comprising one or more than one heteroatoms; sulfonic acid and sulfonate groups; phosphonic acid and phosphonate groups; amine and quaternary ammonium groups.

According to an embodiment, h is zero for each R. In other words, according to this embodiment, the recurring units (R_{PPSU}) are units of formula (L′):

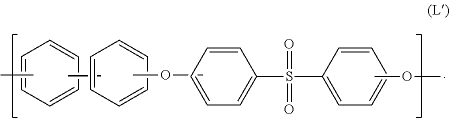

According to another embodiment, the recurring units (R_{PPSU}) are units of formula (L″):

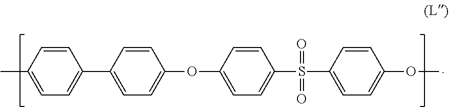

The PPSU polymer of the present invention can therefore be a homopolymer or a copolymer. If it is a copolymer, it can be a random, alternate or block copolymer.

According to an embodiment of the present invention, at least 60 mol. %, at least 70 mol. %, at least 80 mol. %, at least 90 mol. %, at least 95 mol. %, at least 99 mol. % or all of the recurring units in the PPSU are recurring units (R_{PPSU}) of formula (L), (L′) and/or (L″).

When the poly(biphenyl ether sulfone) (PPSU) is a copolymer, it can be made of recurring units (R*_{PPSU}), different from recurring units (R_{PPSU}), such as recurring units of formula (M), (N″) and/or (O):

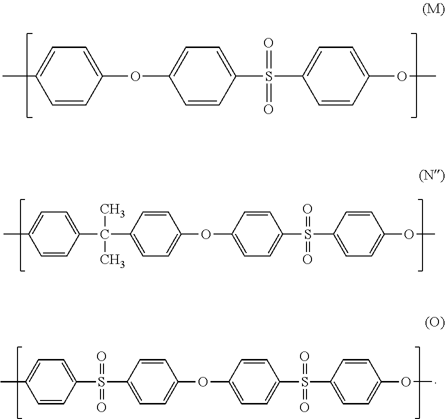

The poly(biphenyl ether sulfone) (PPSU) can also be a blend of a PPSU homopolymer and at least one PPSU copolymer, as described above.

The poly(biphenyl ether sulfone) (PPSU) can be prepared by any method known in the art. It can for example result from the condensation of 4,4′-dihydroxybiphenyl (biphenol) and 4,4′-dichlorodiphenyl sulfone in presence of a base. The reaction of monomer units takes place through nucleophilic aromatic substitution with the elimination of one unit of hydrogen halide as leaving group. It is to be noted however that the structure of the resulting poly(biphenyl ether sulfone) does not depend on the nature of the leaving group.

PPSU is commercially available as Radel® PPSU from Solvay Specialty Polymers USA, L.L.C.

According to the present invention, the powdered polymer material (M) comprises from 5 to 45 wt. % of a poly(aryl ether sulfone) (PAES), for example from 5 to 45 wt. % of a poly(biphenyl ether sulfone) (PPSU).

According to one embodiment, the powdered polymer material (M) comprises from 15 to 43 wt. % or from 17 to 43 wt. %, of poly(biphenyl ether sulfone) (PPSU), based on the total weight of the powdered polymer material (M).

According to the present invention, the weight average molecular weight Mw of the PPSU may be from 30,000 to 80,000 g/mol, for example from 35,000 to 75,000 g/mol or from 40,000 to 70,000 g/mol.

According to the present invention, the melt flow rate or melt flow index (at 365° C. under a weight of 5 kg according to ASTM D1238) (MFR or MFI) of the PPSU may be from 1 to 60 g/10 min, for example from 5 to 50 g/10 min or from 10 to 40 g/10 min.

According to an embodiment, the poly(aryl ether sulfone) (PAES) in the powdered polymer material (M) is a polysulfone (PSU) polymer.

For the purpose of the present invention, a polysulfone (PSU) denotes any polymer comprising at least 50 mol. % recurring units (R_{PSU}) of formula (N), the mol. % being based on the total number of moles in the polymer:

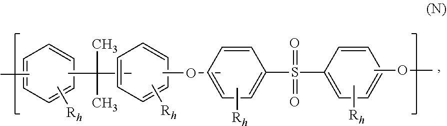

where
R, at each location, is independently selected from a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
h, for each R, is independently zero or an integer ranging from 1 to 4.

According to an embodiment, R is, at each location in formula (N) above, independently selected from the group consisting of a C1-C12 moiety optionally comprising one or more than one heteroatoms; sulfonic acid and sulfonate groups; phosphonic acid and phosphonate groups; amine and quaternary ammonium groups.

According to an embodiment, h is zero for each R. In other words, according to this embodiment, the recurring units (R_{PSU}) are units of formula (N′):

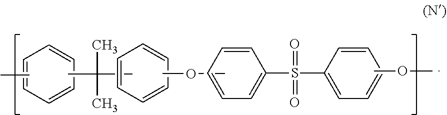

According to an embodiment of the present invention, at least 60 mol. % (based on the total number of moles in the polymer), at least 70 mol. %, at least 80 mol. %, at least 90 mol. %, at least 95 mol. %, at least 99 mol. % or all of the recurring units in the PSU are recurring units (R_{PSU}) of formula (N) and/or (N′).

According to another embodiment, a polysulfone (PSU) denotes any polymer of which more at least 50 mol. % of the recurring units are recurring units (R_{PSU}) of formula (N″):

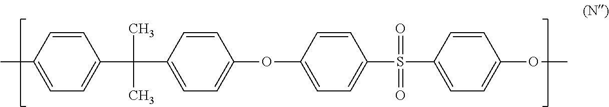

the mol. % being based on the total number of moles in the polymer.

According to an embodiment of the present invention, at least 60 mol. %, at least 70 mol. %, at least 80 mol. %, at least 90 mol. %, at least 95 mol. %, at least 99 mol. % or all of the recurring units in the PSU are recurring units (R_{PSU}) of formula (N″).

The PSU polymer of the present invention can therefore be a homopolymer or a copolymer. If it is a copolymer, it can be a random, alternate or block copolymer.

When the polysulfone (PSU) is a copolymer, it can be made of recurring units (R*_{PSU}), different from recurring units (R_{PSU}), such as recurring units of formula (L″), (M) and/or (O) above described.

The polysulfone (PSU) can also be a blend of a PSU homopolymer and at least one PSU copolymer, as described above.

PSU is available as Udel® PSU from Solvay Specialty Polymers USA, L.L.C.

According to the present invention, the powdered polymer material (M) comprises from 5 to 45 wt. % of a poly(aryl ether sulfone) (PAES), for example from 5 to 45 wt. % of a polysulfone (PSU).

According to one embodiment, the powdered polymer material (M) comprises from 15 to 43 wt. % or from 17 to 43 wt. %, of polysulfone (PSU), based on the total weight of the powdered polymer material (M).

According to the present invention, the weight average molecular weight Mw of the PSU may be from 30,000 to 85,000 g/mol, for example from 35,000 to 75,000 g/mol or from 40,000 to 70,000 g/mol.

According to the present invention, the melt flow rate or melt flow index (at 343° C. under a weight of 5 kg according to ASTM D1238) (MFR or MFI) of the PSU may be from 1 to 50 g/10 min, for example from 2 to 40 g/10 min or from 3 to 30 g/10 min.

According to an embodiment, the poly(aryl ether sulfone) (PAES) in the powdered polymer material (M) is a poly(ether sulfone) (PES) polymer.

For the purpose of the present invention, a poly(ether sulfone) (PES) denotes any polymer comprising at least 50 mol. % recurring units (R_{PES}) of formula (O), the mol. % being based on the total number of moles of recurring units in the polymer:

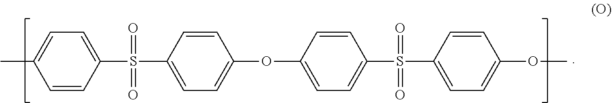

According to an embodiment of the present disclosure, at least 60 mol. % (based on the total number of moles of recurring units in the polymer), at least 70 mol. %, at least 80 mol. %, at least 90 mol. %, at least 95 mol. %, at least 99 mol. % or all of the recurring units in the PES are recurring units (R_{PES}) of formula (O).

PES can be prepared by known methods and is notably available as Veradel® PESU from Solvay Specialty Polymers USA, L.L.C.

The weight average molecular weight (Mw) of PAES, for example PPSU and PSU, can be determined by gel permeation chromatography (GPC) using methylene chloride as a mobile phase (2× 5μ mixed D columns with guard column from Agilent Technologies; flow rate: 1.5 mL/min; injection volume: 20 μL of a 0.2 w/v % sample solution), with polystyrene standards.

More precisely, the weight average molecular weight (Mw) of the PAES polymer can be measured by gel permeation chromatography (GPC), using methylene chloride as the mobile phase. The following detailed method can for example be used: two 5μ mixed D columns with guard column from Agilent Technologies are used for separation. An ultraviolet detector of 254 nm is used to obtain the chromatogram. A flow rate of 1.5 ml/min and injection volume of 20 μL of a 0.2 w/v % solution in mobile phase are selected. Calibration is performed with 12 narrow molecular weight polystyrene standards (Peak molecular weight range: 371,000 to 580 g/mol).

Poly(ether imide) (PEI)

As used herein, a poly(ether imide) (PEI) denotes any polymer comprising at least 50 mol. %, based on the total number of moles in the polymer, of recurring units (R_{PEI}) comprising at least one aromatic ring, at least one imide group, as such and/or in its amic acid form, and at least one ether group. Recurring units (R_{PEI}) may optionally further comprise at least one amide group which is not included in the amic acid form of an imide group.

According to an embodiment, the recurring units (R_{PEI}) are selected from the group consisting of following formulas (I), (II), (III), (IV), (V) and mixtures thereof:

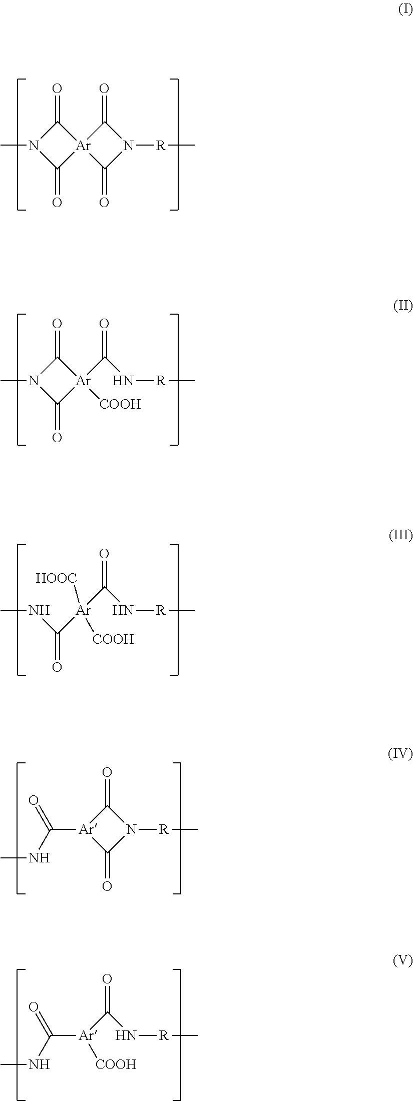

where
Ar is a tetravalent aromatic moiety and is selected from the group consisting of a substituted or unsubstituted, saturated, unsaturated or aromatic monocyclic and polycyclic group having 5 to 50 carbon atoms;
Ar′ is a trivalent aromatic moiety and is selected from the group consisting of a substituted, unsubstituted, saturated, unsaturated, aromatic monocyclic and aromatic polycyclic group having from 5 to 50C atoms; and
R is selected from the group consisting of substituted and unsubstituted divalent organic radicals, for example selected from the group consisting of

(a) aromatic hydrocarbon radicals having 6 to 20 carbon atoms and halogenated derivatives thereof;

(b) straight or branched chain alkylene radicals having 2 to 20 carbon atoms;

(c) cycloalkylene radicals having 3 to 20 carbon atoms, and

(d) divalent radicals of formula (VI):

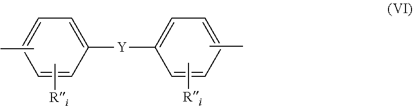

where
Y is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —Cₙ F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and
R″ is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium and
i, for each R″, is independently zero or an integer ranging from 1 to 4, with the provisio that at least one of Ar, Ar′ and R comprise at least one ether group and that the ether group is present in the polymer chain backbone.

According to an embodiment, Ar is selected from the group consisting of formulas:

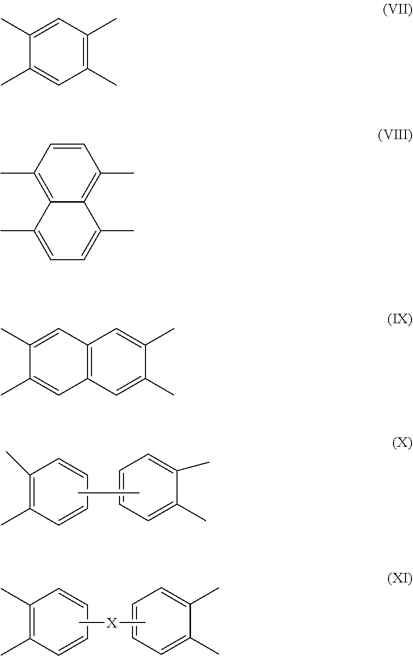

where

X is a divalent moiety, having divalent bonds in the 3,3′, 3,4′, 4,3″ or the 4,4′ positions and is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —Cₙ F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—;

or X is a group of the formula —O—Ar″—O—, wherein Ar″ is a aromatic moiety selected from the group consisting of a substituted or unsubstituted, saturated, unsaturated or aromatic monocyclic and polycyclic group having 5 to 50 carbon atoms.

According to an embodiment, Ar′ is selected from the group consisting of formulas:

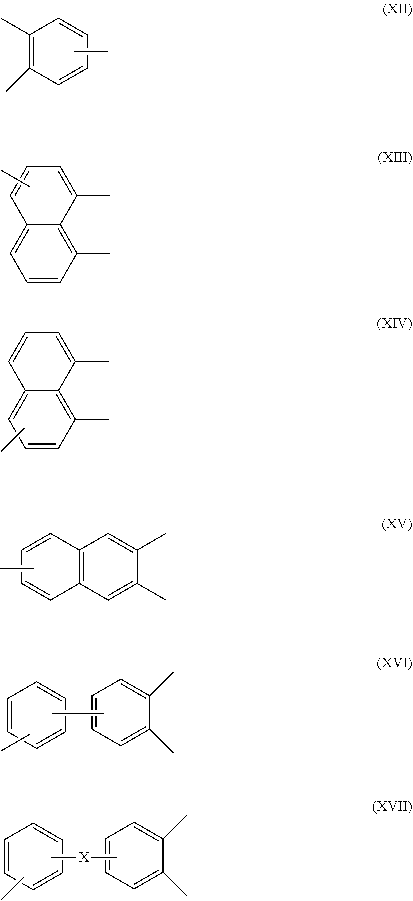

where

X is a divalent moiety, having divalent bonds in the 3,3′, 3,4′, 4,3″ or the 4,4′ positions and is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —Cₙ F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—;

or X is a group of the formula —O—Ar″—O—, wherein Ar″ is a aromatic moiety selected from the group consisting of a substituted or unsubstituted, saturated, unsaturated or aromatic monocyclic and polycyclic group having 5 to 50 carbon atoms.

According to an embodiment of the present disclosure, at least 50 mol. %, at least 60 mol. %, at least 70 mol. %, at least 80 mol. %, at least 90 mol. %, at least 95 mol. %, at least 99 mol. % or all of the recurring units in the PEI are recurring units (RPEI) of formulas (I), (II), (III), (IV), (V) and/or mixtures thereof, as defined above.

According to an embodiment, a poly(ether imide) (PEI) denotes any polymer comprising at least 50 mol. %, based on the total number of moles in the polymer, of recurring units (R_{PEI}) of formula (VII):

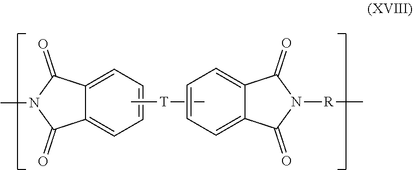

where
R is selected from the group consisting of substituted and unsubstituted divalent organic radicals, for example selected from the group consisting of

(a) aromatic hydrocarbon radicals having 6 to 20 carbon atoms and halogenated derivatives thereof;

(b) straight or branched chain alkylene radicals having 2 to 20 carbon atoms;

(c) cycloalkylene radicals having 3 to 20 carbon atoms, and

(d) divalent radicals of formula (VI):

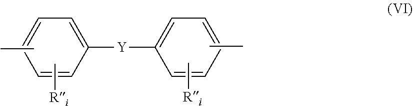

where
Y is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —Cₙ F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and
R″ is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium and
i, for each R″, is independently zero or an integer ranging from 1 to 4, with the provisio that at least one of Ar, Ar′ and R comprise at least one ether group and that the ether group is present in the polymer chain backbone.
T can either be

—O— or —O—Ar″—O—

wherein the divalent bonds of the —O— or the —O—Ar″—O— group are in the 3,3′, 3,4′, 4,3′, or the 4,4′ positions,

wherein Ar″ is a aromatic moiety selected from the group consisting of a substituted or unsubstituted, saturated, unsaturated or aromatic monocyclic and polycyclic group having 5 to 50 carbon atoms, for example a substituted or unsubtitutated phenylene, a substitued or unsubstituted biphenyl group, a susbtituted ou unsubstituted naphtalene group or a moiety comprising two substituted or unsubtitutated phenylene.

According to an embodiment of the present disclosure, Ar″ is of the general formula (VI), as detailed above; for example, Ar″ is of formula (XIX):

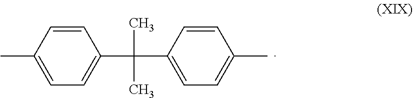

The polyetherimides (PEI) of the present invention may be prepared by any of the methods well-known to those skilled in the art including the reaction of a diamino compound of the formula H₂N—R—NH₂ (XX), where R is as defined before, with any aromatic bis(ether anhydride)s of the formula (XXI):

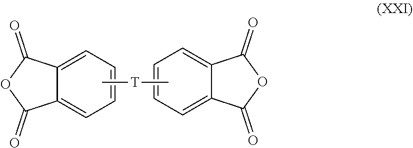

where T as defined before.

In general, the preparation can be carried out in solvents, e.g., o-dichlorobenzene, m-cresol/toluene, N,N-dimethylacetamide, at temperatures ranging from 20° C. to 250° C.

Alternatively, these polyetherimides can be prepared by melt polymerization of any dianhydrides of formula (XXI) with any diamino compound of formula (XX) while heating the mixture of the ingredients at elevated temperatures with concurrent intermixing.

The aromatic bis(ether anhydride)s of formula (XXI) include, for example:

2,2-bis[4-(2,3-dicarboxyphenoxy)phenyl]propane dianhydride;

4,4′-bis(2,3-dicarboxyphenoxy)diphenyl ether dianhydride;

1,3-bis(2,3-dicarboxyphenoxy)benzene dianhydride;

4,4′-bis(2,3-dicarboxyphenoxy)diphenyl sulfide dianhydride;

1,4-bis(2,3-dicarboxyphenoxy)benzene dianhydride;

4,4′-bis(2,3-dicarboxyphenoxy)benzophenone dianhydride;

4,4′-bis(2,3-dicarboxyphenoxy)diphenyl sulfone dianhydride;

2,2-bis[4 (3,4-dicarboxyphenoxy)phenyl]propane dianhydride;

4,4′-bis(3,4-dicarboxyphenoxy)diphenyl ether dianhydride;

4,4′-bis(3,4-dicarboxyphenoxy)diphenyl sulfide dianhydride;

1,3-bis(3,4-dicarboxyphenoxy)benzene dianhydride;

1,4-bis(3,4-dicarboxyphenoxy)benzene dianhydride;

4,4′-bis(3,4-dicarboxyphenoxy)benzophenone dianhydride;

4-(2,3-dicarboxyphenoxy)-4′-(3,4-dicarboxyphenoxy)diphenyl-2,2-propane dianhydride; and mixtures of such dianhydrides.

The organic diamines of formula (XX) are chosen from the group consisting of m-phenylenediamine, p-phenylenediamine, 2,2-bis(p-aminophenyl)propane, 4,4′-diaminodiphenyl-methane, 4,4′-diaminodiphenyl sulfide, 4,4′-diamino diphenyl sulfone, 4,4′-diaminodiphenyl ether, 1,5-diaminonaphthalene, 3,3′-dimethylbenzidine, 3,3′-dimethoxybenzidine, and mixtures thereof; preferably, the organic diamines of formula (XX) are chosen from the group consisting of m-phenylenediamine and p-phenylenediamine and mixture thereof.

According to an embodiment, a poly(ether imide) (PEI) denotes any polymer comprising at least 50 mol. %, based on the total number of moles in the polymer, of recurring units (R_{PEI}) of formulas (XXIII) or (XXIV), in imide forms, or their corresponding amic acid forms and mixtures thereof:

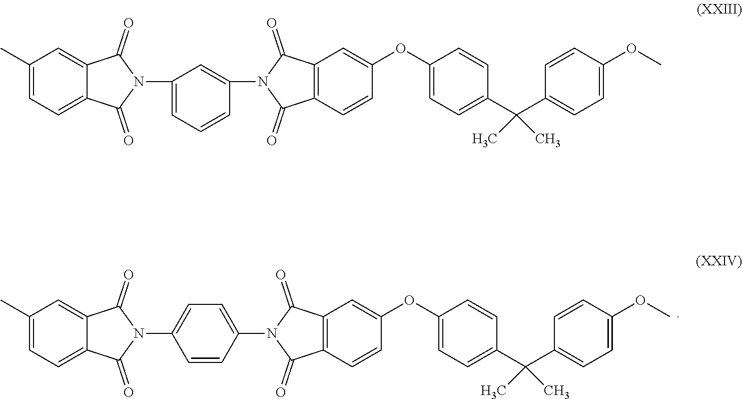

In a preferred embodiment of the present invention, at least 50 mol. %, at least 60 mol. %, at least 70 mol. %, at least 80 mol. %, at least 90 mol. %, at least 95 mol. %, at least 99 mol. % or all of the recurring units in the PEI are recurring units (R_{PEI}) of formulas (XXIII) or (XXIV), in imide forms, or their corresponding amic acid forms and mixtures thereof.

Such aromatic polyimides are notably commercially available from Sabic Innovative Plastics as ULTEM® polyetherimides.

The material (M) can comprise only one PEI. Alternatively, it can comprise several PEI, for example two, three, or even more than three PEI.

In a specific embodiment, the PEI polymer has a weight average molecular weight (Mw) of 10,000 to 150,000 g/mol, as measured by gel permeation chromatography, using a polystyrene standard.

In a specific embodiment, the PEI polymer has an intrinsic viscosity greater than 0.2 deciliters per gram (dl/g), beneficially 0.35 to 0.7 dl/g measured in m-cresol at 25° C.

According to the present invention, the melt flow rate or melt flow index (at 337° C. under a weight of 6.6 kg according to ASTM D1238) (MFR or MFI) of the PEI may be from 0.1 to 40 g/10 min, for example from 2 to 30 g/10 min or from 3 to 25 g/10 min.

In a specific embodiment, the PEI polymer has a Tg ranging from 160 and 270° C., as measured by differential scanning calorimetry (DSC) according to ASTM D3418, for example ranging from 170 and 260° C., from 180 and 250° C.

Polycarbonate (PC)

As used herein, a polycarbonate (PC) denotes any polymer comprising at least 50 wt. % of the recurring units (R_{PC}) comprising at least one optionally substituted arylene group and at least one carbonate group (—O—C(═O)—O).

The arylene group contained in the recurring units (R_{PC}) is preferably selected from optionally substituted phenylenes and naphthylenes and can substituted or unsubstituted.

The recurring units (R_{PC}) can be selected from those obtainable by the polycondensation reaction of a carbonic acid derivative, typically diphenyl carbonate Ph-O—C(═O)—O-Ph, wherein Ph is phenyl, or phosgene Cl—C(═O)—Cl, and at least one optionally substituted aromatic diol (D) HO—R—OH in which R is a C6-C50 divalent radical comprising at least one arylene group.

The optionally substituted arylene group of the aromatic diol (D) is preferably selected from optionally substituted phenylenes and optionally substituted naphthylenes.

The aromatic diol (D) is preferably selected from aromatic diols complying with formulas (D-A) and (D-B) below:

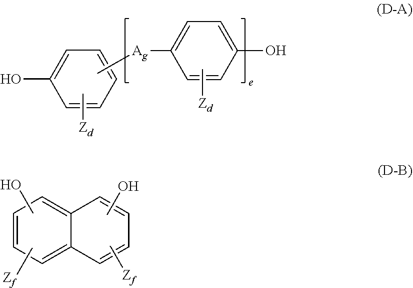

where

A is selected from the group consisting of C1-C8 alkylenes, C2-C8 alkylidenes, C5-C15 cycloalkylenes, C5-C15 cycloalkylidenes, carbonyl atom, oxygen atom, sulfur atom, SO and SO₂,

Z is selected from F, Cl, Br, I, C1-C4 alkyls; if several Z radicals are substituents, they may be identical or different from one another;

e denotes an integer from 0 to 1;

g denotes an integer from 0 to 1;

d denotes an integer from 0 to 4; and

f denotes an integer from 0 to 3.

Preferably, aromatic diols (D) are selected in the group consisting of 2,2 bis-(4-hydroxyphenyl)-propane (bisphenol A), 2,2 bis (3,5 dimethyl 4 hydroxyphenyl) propane, 2,2,4-trimethyl cyclohexyl 1,1-diphenol and 1,1-bis-(4-hydroxy-phenyl)-cyclohexane.

Among the aromatic polycarbonates suitable in the practice of the invention as aromatic polycarbonates (PC) are included phenolphthalein-based polycarbonates, copolycarbonates and terpolycarbonates.

According to an embodiment of the present invention, more than 60 wt. %, more than 70 wt. %, more than 80 wt. %, more than 90 wt. %, more than 95 wt. %, more than 98 wt. %, or 100 wt. % of the recurring units of the aromatic polycarbonate are recurring units (R_{PC}).

According to another embodiment, the recurring units of the aromatic polycarbonate consist essentially of recurring units (R_{PC}) obtained by the polycondensation reaction of a carbonic acid derivative with bisphenol A.

Poly(phenyl ether) (PPE)

As used herein, the term poly(phenyl ether) (PPE) is intended denote a polymer comprising at least 50 mol. % of recurring units (R_{PPE}) of formula (W):

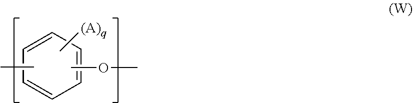

where

A are independently selected from a C1-C30 alkyl groups, and

q is 0, 1, 2, 3 or 4.

According to an embodiment, at least 60 mol. %, 70 mol. %, 80 mol. %, 90 mol. %, 95 mol. %, 99 mol. %, and most preferably all recurring units in the PPE are recurring units (R_{PPE}).

According to another embodiment, A represents CH₃ and q is 2.

According to another embodiment, the phenylene moieties in the PPE have 1,4-linkages.

The PPE is preferably poly-2,6-dimethyl phenylene ether.

Optional Components

The powdered polymer material (M) of the present invention may further comprise a flow agent, also called sometimes flow aid. This flow agent may for example be hydrophilic. Examples of hydrophilic flow aids are inorganic pigments notably selected from the group consisting of silicas, aluminas and titanium oxide. Mention can be made of fumed silica.

Fumed silicas are commercially available under the trade name Aerosil® (Evonik) and Cab-O-Sil® (Cabot).

According to an embodiment of the present invention, the powdered polymer material (M) comprises from 0.01 to 10 wt. %, preferably from 0.05 to 5 wt. %, more preferably from 0.25 to 1 wt. %, of a flow agent, for example of fumed silica.

These silicas are composed of nanometric primary particles (typically between 5 and 50 nm for fumed silicas). These primary particles are combined to form aggregates. In use as flow agent, silicas are found in various forms (elementary particles and aggregates).

The powdered polymer material (M) of the present invention may further comprise one or several additives, such as lubricants, heat stabilizers, light stabilizers, antioxidants, pigments, processing aids, dyes, fillers, nanofillers or electomagnetic absorbers. Examples of these optional additives are titanium dioxide, zinc oxide, cerium oxide, silica or zinc sulphide, glass fibers, carbon fibers.

The powdered polymer material (M) of the present invention may further comprise flame retardants such as halogen and halogen free flame retardants.

Method for Making a Three-Dimensional (3D) Object

The additive manufacturing method for making a three-dimensional (3D) object of the present invention comprises:

a) the provision of a powdered polymer material (M) comprising:
from 55 to 95 wt. % of at least one polymer (P1) having a melting temperature (Tm) greater than 270° C., as measured by differential scanning calorimetry (DSC) according to ASTM D3418, and
from 5 to 45 wt. % of at least one polymer (P2) having a glass transition temperature (Tg) between 130° C. and 240° C., and no melting peak, as measured by differential scanning calorimetry (DSC) according to ASTM D3418,

based on the total weight of the powdered polymer material (M);

b) the deposition of successive layers of the powdered polymer material (M); and

c) the selective sintering of each layer prior to deposition of the subsequent layer,

wherein the powdered polymer material (M) is heated before step c) to a temperature Tp (° C.):

Tp<Tg+25
for example Tp≤Tg+20, or Tp≤Tg+15, or Tp≤Tg+10,

wherein Tg (° C.) is the glass transition temperature of the PEI polymer, as measured by differential scanning calorimetry (DSC) according to ASTM D3418.

The method of the present invention is conducted at a temperature where the thermal aging of the powdered polymer material, which can be assessed by the polymer aspect (for example color), the coalescence ability and the disaggregation ability, is significantly reduced. In other words, the powdered material shows no significant signs of thermal aging, can be recycled and use to prepare a new article by laser sintering 3D printing, as such or in combination with neat powdered polymer material.

According to an embodiment, the step of printing layers comprises selective sintering by means of a high power energy source, for example a high power laser source such as an electromagnetic beam source.

The 3D object/article/part may be built on substrate, for example an horizontal substrate and/or on a planar substrate. The substrate may be moveable in all directions, for example in the horizontal or vertical direction. During the 3D printing process, the substrate can, for example, be lowered, in order for the successive layer of unsintered polymeric material to be sintered on top of the former layer of sintered polymeric material.

According to an embodiment, the process further comprises a step consisting in producing a support structure. According to this embodiment, the 3D object/article/part is built upon the support structure and both the support structure and the 3D object/article/part are produced using the same AM method. The support structure may be useful in multiple situations. For example, the support structure may be useful in providing sufficient support to the printed or under-printing, 3D object/article/part, in order to avoid distortion of the shape 3D object/article/part, especially when this 3D object/article/part is not planar. This is particularly true when the temperature used to maintain the printed or under-printing, 3D object/article/part is below the re-solidification temperature of the powder.

The method of manufacture usually takes place using a printer. The printer may comprise a sintering chamber and a powder bed, both maintained at determined at specific temperatures.

The powder to be printed can be pre-heated to a processing temperature (Tp), above the glass transition (Tg) temperature of the powder. The preheating of the powder makes it easier for the laser to raise the temperature of the selected regions of layer of unfused powder to the melting point. The laser causes fusion of the powder only in locations specified by the input. Laser energy exposure is typically selected based on the polymer in use and to avoid polymer degradation.

According to the present invention, the powder is not significantly affected by the long-term exposure to the processing temperature and presents a set of characteristics (namely powder aspect and color, disaggregation and coalescence abilities) which is comparable to a new, unprocessed polymer material. This makes the used powder completely suitable for reuse in a laser sintering 3D printing process, without impacting the appearance and mechanical performances of the resulting printed article (notably the expected performance of the polymer materials).

Method for Producing The Powdered Polymer Material (M)

The present invention also relates to a method for the production of a powdered polymer material (M), comprising at least one polymer (P1) having a melting temperature (Tm) greater than 270° C., and at least one polymer (P2) having a glass transition temperature (Tg) between 130° C. and 240° C., and no melting peak, said method comprising: a) a step of mixing the polymers together, for example blend compounding the polymers, and b) a step of grinding the resulting blended formulation, for example in the form of pellets, in order to obtain a powdered polymer material (M) having for example a d_{0.5}-value ranging from 25 from 90 μm, for example from 35 to 88 μm, or from 45 to 85 μm, as measured by laser scattering in isopropanol. The d_{0.5}, also called D50, is known as the median diameter or the medium value of the particle size distribution, it is the value of the particle diameter at 50% in the cumulative distribution. It means that 50% of the particles in the sample are larger than the d_{0.5}-value, and 50% of the particles in the sample are smaller than the d_{0.5}-value. D50 is usually used to represent the particle size of group of particles.

The pellets of blended formulations can for example be ground in a pinned disk mill, a jet mill/fluidized jet mil with classifier, an impact mill plus classifier, a pin/pin-beater mill or a wet grinding mill, or a combination of those equipment.

The pellets of blended formulations can be cooled before step c) to a temperature below the temperature at which the material becomes brittle, for example below 25° C. before being ground.

The step of grinding can also take place with additional cooling. Cooling can take place by means of liquid nitrogen or dry ice.

The ground powder can be separated, preferably in an air separator or classifier, to obtain a predetermined fraction spectrum.

According to an embodiment, the method for the production of a powdered polymer material (M) may further comprise, a step consisting in exposing the powder to a temperature (Ta) ranging from the glass transition temperature (Tg) of the polymer (P1), for example the PAEK polymer, and the melting temperature (Tm) of the polymer (P1), for example the PAEK polymer, both Tg and Tm being measured using differential scanning calorimetry (DSC) according to ASTM D3418. The temperature Ta can be selected to be at least 20° C. above the Tg of the polymer (P1), for example the PAEK polymer, for example at least 30, 40 or 50° C. above the Tg of the polymer (P1), for example of the PAEK polymer. The temperature Ta can be selected to be at least 5° C. below the Tm of the polymer (P1), for example the PAEK polymer, for example at least 10, 20 or 30° C. below the Tm of the polymer (P1), for example the PAEK polymer. The exposition of the powder to the temperature Ta can for example be by heat-treatment and can take place in an oven (static, continuous, batch, convection), fluid bed heaters. The exposition of the powder to the temperature Ta can alternatively be by irradiation with electromagnetic or particle radiation. The heat treatment can be conducted under air or under inert atmosphere. Preferably, the heat treatment is conducted under inert atmosphere, more preferably under an atmosphere containing less than 2% oxygen.

The present invention also relates to the powdered polymer material (M), comprising at least one polymer (P1) having a melting temperature (Tm) greater than 270° C., and at least one polymer (P2) having a glass transition temperature (Tg) between 130° C. and 240° C., and no melting peak, obtainable by the process described above, for use in the manufacture of a 3D object using SLS.

3D Objects and Articles

The 3D objects or articles obtainable by such method of manufacture can be used in a variety of final applications. Mention can be made in particular of implantable device, medical device, dental prostheses, brackets and complex shaped parts in the aerospace industry and under-the-hood parts in the automotive industry.

Should the disclosure of any patents, patent applications, and publications which are incorporated herein by reference conflict with the description of the present application to the extent that it may render a term unclear, the present description shall take precedence.

### EXAMPLES

The disclosure will be now described in more detail with reference to the following examples, whose purpose is merely illustrative and not intended to limit the scope of the disclosure.

Starting Materials

PPS: Ryton® QA281 N having an MFI of 700 g/10 min (316° C./5 kg).

TABLE 1

| | PPS |
|---|---|
| MFI (316° C./5 kg) | 700 g/10 min |
| Tm (° C.) | 285 |
| Tg (° C.) | 100 |

PPSU: a poly(biphenyl ether sulfone) (PPSU) with a MFI of 17 g/10 min (365° C./5 kg), prepared according to the following process:

The synthesis of the PPSU was achieved by the reaction in a 1 L flask of 83.8 g of 4,4′-biphenol (0.450 mol), 131.17 g of 4,4′-dichlorodiphenyl sulfone (0.457 mol) dissolved in a mixture of 400 g of sulfolane with the addition of 66.5 g (0.481 mol) of dry K₂CO₃.

The reaction mixture was heated up to 210° C. and maintained at this temperature until the polymer had the expected Mw. An excess of methyl chloride was then added to the reaction.

The reaction mixture was diluted with 600 g of MCB. The poly(biphenyl ether sulfone) was recovered by filtration of the salts, coagulation, washing and drying.

TABLE 2

| | PPSU |
|---|---|
| MFI (365° C./5 kg) | 17 g/10 min |
| Tg (° C.) | 220 |

Test Methods

*Thermal Transitions (Tg, Tm)

The glass transition and melting temperatures of the polymers were measured using differential scanning calorimetry (DSC) according to ASTM D3418 employing a heating and cooling rate of 20° C./min. Three scans were used for each DSC test: a first heat up to 400° C., followed by a first cool down to 30° C., followed by a second heat up to 400° C. The Tg and the Tm were determined from the second heat up. DSC was performed on a TA Instruments DSC Q20 with nitrogen as carrier gas (99.998% purity, 50 mL/min).

*MFI

The melt flow indices of the polymers were measured according to ASTM D-1238, using a weight of 5 kg and a temperature of 316° C. or 365° C. The measurements were conducted on a Dynisco D4001 Melt Flow Indexer.

*PSD (d_{0.5})

The PSD (volume distribution) of the powdered polymer materials were determined by an average of 3 runs using laser scattering Microtrac S3500 analyzer in wet mode (128 channels, between 0.0215 and 1408 μm). The solvent was isopropanol with a refractive index of 1.38 and the particles were assumed to have a refractive index of 1.59. The ultrasonic mode was enabled (25 W/60 seconds) and the flow was set at 55%.

Blend Compounding

The formulations were melt compounded using a 26 mm diameter Coperion® ZSK-26 co-rotating partially intermeshing twin screw extruder having an L/D ratio of 48:1. The barrel sections 2 through 12 and the die were heated to set point temperatures as follows:

Barrels 2-12: decreasing from 350° C. to 300° C.

Die: 350° C.

The resin blends were fed at barrel section 1 using a gravimetric feeder at throughput rates in the range 30-40 lb/hr. The extruder was operated at screw speeds of around 200 RPM. Vacuum was applied at barrel zone 10 with a vacuum level of about 27 inches of mercury. A single-hole die was used for all the compounds to give a filament approximately 2.6 to 2.7 mm in diameter and the polymer filament exiting the die was cooled in water and fed to the pelletizer to generate pellets approximately 2.7 mm in length.

Powdered Polymer Material Preparation

The blended formulations were slowly fed in combination with crushed dry ice into the feed port of a Retsch SR300 rotor mill, fitted with a 0.5 mm opening Conidur screen mounted in the reverse flow position and standard 6-blade rotor with a speed of 10,000 rpm.

The materials were re-mixed with crushed dry ice at 1 part resin and 2 parts dry ice to the Retsch SR300 with a 0.08 mm screen, also in the reverse flow position with a standard 6-blade rotor at 10,000 rpm.

TABLE 3

| | Blend |
|---|---|
| | PPS/PPSU 63/37 wt/wt |
| d_{0.5}-value (μm) | 43.1 |

Heat Treatment

The aim of the heat treatments was to simulate long-term printing conditions within the print bed of an SLS printer and evaluate recyclability of the materials. More precisely, the materials were subjected to different heat treatment temperatures for 16 hours in an air convection oven and then tested for their retained sintering (coalescence) capability, thereby simulating a printing cycle. Recyclability was tested by examining remaining particle coalescence ability. Additionally, the powders were evaluated for their aspect and their disaggregation following heat treatments, that-is-to-say their ability to be broken apart by traditional sieving.

Generally speaking, as an example, a color change from white to off-white was acceptable, while a color change from white or off-white to brown, dark brown or black was considered as failing the recyclability requirement. Also, a powder material which could not be broken apart by traditional sieving, after a 16-hour long heat treatment at a certain temperature, was also considered as failing the recyclability requirement.

Hot Stage Microscopy

The aim of the hot stage microscopy tests was to study particle coalescence under experimental conditions that simulate the sintering step of the method for making a 3D object of the present invention, in order to compare sintering behaviour as a function of the exposition of different materials to high-temperature conditions within an air convection oven for 16 hours.

Coalescence was evaluated on a Keyence VHX 600K optical microscope with a digital zoom of 200×. A Linkam T96-PE hot-stage attachment was utilized in order to increase the temperature of the material in order to simulate the increased temperature of the material within an SLS printer upon printing.

The material was heated quickly (100° C./min) to 260° C. Following the rapid pre-heat, the material was subjected to a temperature increase at 20° C./min until reaching 400° C., at which point the temperature was held constant in order to observe coalescence. The temperature of 400° C. hereby simulates the energy source (for example laser) used to sinter selected regions of layer of unfused powder in a SLS equipment.

Coalescence was measured by observing two particles that were adjacent prior to heating. During the heating and isothermal phase at 400° C., the particles were observed to coalesce together, with a neck or bridge, formed between the two during intermediate steps.

Definitions and Results

Disaggregation

0=Not Aggregated: Powder particles are not closely associated together and the powder is loosely flowing.

1=Easy Disaggregation: Powder particles are closely associated together but can be easily broken back apart by traditional sieving.

2=Difficult Disaggregation: Powder particles have slightly fused together and cannot be broken back apart by traditional sieving.

3=No Disaggregation: Powder particles have fused together with no possible separation except by grinding.

Coalescence

Yes: Particles exhibit rapid coalescence between the temperatures of 285° C. and 295° C. during an increasing temperature ramp with rate of 20° C./min.

No: Particles do not exhibit any coalescence between the temperatures of 285° C. and 295° C. during an increasing temperature ramp with rate of 20° C./min.

TABLE 6

| | E1 | E2 | E3 | E4c | E5c |
|---|---|---|---|---|---|
| | Blend 1 (PPS/PPSU, Tg PPSU = 220° C.) | | | | |
| Treatment | none | 200 | 230 | 245 | 270 |
| temperature | | | | | |
| (° C.) | | | | | |
| Corresponding | n/a | Tg − 20 | Tg + 10 | Tg + 25 | Tg + 50 |
| Tp (° C.) | | | | | |
| Powder aspect | White | Off-white | Off-white | Off-white | Dark |
| | | | | | brown |
| Disaggregation | 0 | 1 | 1 | 2 | 3 |
| Particule | Yes | Yes | Yes | Yes | No |
| coalescence | | | | | |

The color, the disaggregation and the coalescence ability of the powder of example E1 (no heat treatment) simulates the behaviour of the powder when used for the first time in a SLS printer.

The color, the disaggregation and the coalescence ability of the powder of example E2, which has been submitted to a 16-hour heat treatment at 200° C. (temperature lower than the glass transition of the amorphous polymer of powdered polymer material, i.e. PPSU) and E3, which has been submitted to a 16-hour heat treatment at 230° C. (temperature higher than the glass transition of the amorphous polymer of powdered polymer material, i.e. PPSU) are shown to be comparable to example E1.

The powder of example E4c however demonstrates difficult disaggregation ability. The powder of example E4C treated 16 hours at a temperature of 255° C. (temperature 25° C. higher than the glass transition of the PPSU polymer) cannot not be recycled.

The powder of example E5c demonstrates a non-acceptable change of color, no possible disaggregation and no coalescence, which make it not recyclable at all.

1. An additive manufacturing method for making a three-dimensional (3D) object, comprising:
a) providing a powdered polymer material (M) comprising:
from 55 to 95 wt. % of at least one polymer (P1) having a melting temperature (Tm) greater than 270° C., as measured by differential scanning calorimetry (DSC) according to ASTM D3418, and
from 5 to 45 wt. % of at least one polymer (P2) having a glass transition temperature (Tg) between 130° C. and 240° C., and no melting peak, as measured by differential scanning calorimetry (DSC) according to ASTM D3418, based on the total weight of the powdered polymer material (M);
b) depositing successive layers of the powdered polymer material (M); and
c) selectively sintering each layer prior to deposition of the subsequent layer,
wherein the powdered polymer material (M) is heated before step c) to a temperature Tp (° C.):
Tp<Tg+25
wherein Tg (° C.) is the glass transition temperature of the P2 polymer.

2. The method of claim 1, wherein the powdered polymer material (M) has a d_{0.5}-value ranging between 25 and 90 μm, as measured by laser scattering in isopropanol.

3. The method of claim 1, wherein P1 is selected from the group consisting of a poly(aryl ether ketone) (PAEK), a polyphenylene sulphide (PPS), a polyphtalamide (PPA), a semi-aromatic polyester and an aromatic polyesters (PE).

4. The method of claim 1, wherein P2 is selected from the group consisting of a poly(aryl ether sulfone) (PAES), a poly(ether imide) (PEI), a polycarbonate (PC), a poly(phenyl ether) (PPE), an amorphous polyamide with a glass transition temperature above 130° C. and an amorphous aromatic polyester.

5. The method of claim 1, wherein P1 is a PPS comprising at least 50 mol. % of recurring units (R_{PPS}) of formula (U) (mol. % being based on the total number of moles of recurring units in the PPS polymer): 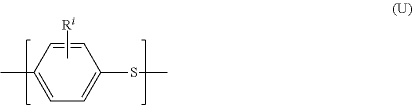
where
R is independently selected from the group consisting of halogen, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and
i is independently zero or an integer from 1 to 4.

6. The method of claim 1, wherein P2 is a poly(aryl ether sulfone) (PAES) selected from the group consisting of poly (PPSU), polysulfone (PSU) and poly(ether sulfone) (PES).

7. The method of claim 1, wherein the powdered polymer material (M) is heated before step c) to a temperature Tp (° C.):
Tp<Tg+20
wherein Tg (° C.) is the glass transition temperature of the P2 polymer, as measured by differential scanning calorimetry (DSC) according to ASTM D3418.

8. The method of claim 1, wherein the powdered polymer material (M) comprises:
from 56 to 80 wt. % of at least one polymer (P1) having a melting temperature (Tm) greater than 270° C., as measured by differential scanning calorimetry (DSC) according to ASTM D3418, and
from 20 to 44 wt. % of at least one polymer (P2) having a glass transition temperature (Tg) between 130° C. and 240° C., and no melting peak, as measured by differential scanning calorimetry (DSC) according to ASTM D3418, based on the total weight of the powdered polymer material (M).

9. The method of claim 1, wherein the powdered polymer material (M) further comprises 0.01 to 10 wt. % of a flow agent.

10. The method of claim 1, wherein the P2 polymer has a Tg ranging from 160 and 250° C., as measured by differential scanning calorimetry (DSC) according to ASTM D3418.

11. The method of claim 1, wherein the powdered polymer material (M) is obtained by grinding a blend of at least P1 and P2, the blend being optionally cooled down to a temperature a temperature below 25° C. before and/or during grinding.

12. The method of claim 1, wherein step
c) comprises selective sintering by means of an electromagnetic radiation of the powder.

13. A three-dimensional (3D) object obtainable by laser sintering from a powdered polymer material (M) comprising:
from 55 to 95 wt. % of at least one polymer (P1) having a melting temperature (Tm) greater than 270° C., as measured by differential scanning calorimetry (DSC) according to ASTM D3418, and
from 5 to 45 wt. % of at least one polymer (P2) having a glass transition temperature (Tg) between 130° C. and 240° C., and no melting peak, as measured by differential scanning calorimetry (DSC) according to ASTM D3418, based on the total weight of the powdered polymer material (M).

14. The object of claim 12, wherein the powdered polymer material (M) comprises recycled material.

15. A method for manufacturing a three-dimensional (3D) object using selective laser sintering (SLS) with a powdered polymer material (M) comprising, based on the total weight of the powdered polymer material (M):
from 55 to 95 wt. % of at least one polymer (P1) having a melting temperature (Tm) greater than 270° C., as measured by differential scanning calorimetry (DSC) according to ASTM D3418, and
from 5 to 45 wt. % of at least one polymer (P2) having a glass transition temperature (Tg) between 130° C. and 240° C., and no melting peak, as measured by differential scanning calorimetry (DSC) according to ASTM D3418.
